(19) United States
(12) Patent Application Publication
(10) Pub. No.: US 2026/0214526 A1
(43) Pub. Date: Jul. 23, 2026

(54) SYSTEMS AND METHODS FOR PROVIDING RADIO ACCESS NETWORK SERVICE CONTINUITY DURING USER EQUIPMENT MOBILITY

(71) Applicant: Verizon Patent and Licensing Inc., Basking Ridge, NJ (US)

(72) Inventors: Susan Wu SANDERS, Bridgewater, NJ (US); Xin WANG, Morris Plains, NJ (US); Anil Babu VONTIKOMMU, Morris Plains, NJ (US); Cindy Yuexin DONG, Bridgewater, NJ (US); Shuang Echo YANG, Naperville, IL (US)

(73) Assignee: Verizon Patent and Licensing Inc., Basking Ridge, NJ (US)

(21) Appl. No.: 19/030,464

(22) Filed: Jan. 17, 2025

(51) Int. Cl. H04W 36/00

(52) U.S. Cl. CPC H04W 36/00835; H04W 36/0058

(57) ABSTRACT

A device may configure a list of services and fallback services for a user equipment (UE) based on parameters, and may maintain active service information for the UE within a serving cell. The device may instruct the UE to perform an active search for neighboring cells that support a service of the services, and may determine whether a neighboring cell that supports the service is available based on the active search performed by the UE. The device may selectively instruct, based on determining that the neighboring cell that supports the service is available, the UE to switch to the neighboring cell to maintain service continuity for the service, or may instruct the UE to switch to a priority fallback service based on determining that the neighboring cell that supports the service is not available.

### BACKGROUND

In the rapidly evolving landscape of fifth-generation (5G) wireless technology, service providers are confronted with the challenge of deploying services in a Standalone (SA) network that are not uniformly available across the entire network.

### BRIEF DESCRIPTION OF THE DRAWINGS

FIGS. 1A-1N are diagrams of an example associated with providing radio access network (RAN) service continuity during user equipment (UE) mobility.

FIG. 2 is a diagram of an example environment in which systems and/or methods described herein may be implemented.

FIG. 3 is a diagram of example components of one or more devices of FIG. 2.

FIG. 4 is a flowchart of an example process for providing RAN service continuity during UE mobility.

### DETAILED DESCRIPTION OF EXAMPLE EMBODIMENTS

The following detailed description of example implementations refers to the accompanying drawings. The same reference numbers in different drawings may identify the same or similar elements.

As a result of deploying services in an SA network that are not uniformly available across the entire network, ensuring seamless service continuity and mitigating service interruptions for UEs as the UEs move across various parts of the network is becoming increasingly difficult. This is particularly the case for specialized services that may only be available in certain geographic areas or on specific frequency layers within the network. Thus, current techniques for providing services to mobile UEs consume computing resources (e.g., processing resources, memory resources, communication resources, and/or the like), networking resources, and/or other resources associated with failing to provide a continuous service to a mobile UE, handling degradation of the service for a mobile UE, handling customer complaints associated with the degradation of the service, and/or the like.

Some implementations described herein provide a device (e.g., a RAN) that provides RAN service continuity during UE mobility. For example, an operator may define a list of services and fallback services. Then the defined services information may propagate to the RAN either via manual configuration at the RAN or via automatic configuration from a self-organizing network (SON). Hence, the RAN may configure a list of services and fallback services for a UE based on parameters, and may maintain active service information for the UE within a serving cell. The RAN may instruct the UE to perform an active search for neighboring cells that support a service of the services, and may determine whether a neighboring cell that supports the service is available based on the active search performed by the UE. The RAN may selectively instruct, based on determining that the neighboring cell that supports the service is available, the UE to switch to the neighboring cell to maintain service continuity for the service, or may instruct the UE to switch to a priority fallback service based on determining that the neighboring cell that supports the service is not available.

In this way, the RAN provides RAN service continuity during UE mobility. For example, the RAN may enhance mobility support to improve service delivery across non-homogeneous deployment in a 5G SA network. The RAN may configure a list of services and fallback services for a UE based on various parameters. The RAN may maintain active service information for the UE within the serving cell, which can be received through extended UE context information. The RAN may instruct the UE to perform an active search for neighboring cells that support a service and may determine the availability of the neighboring cells based on the active search performed by the UE. Based on the determination, the RAN may instruct the UE to either switch to the neighboring cell to maintain service continuity for the service or switch to a priority fallback service if the service is not available. Thus, the RAN may conserve computing resources, networking resources, and/or other resources that would have otherwise been consumed by failing to provide a continuous service to a mobile UE, handling degradation of the service for a mobile UE, handling customer complaints associated with the degradation of the service, and/or the like.

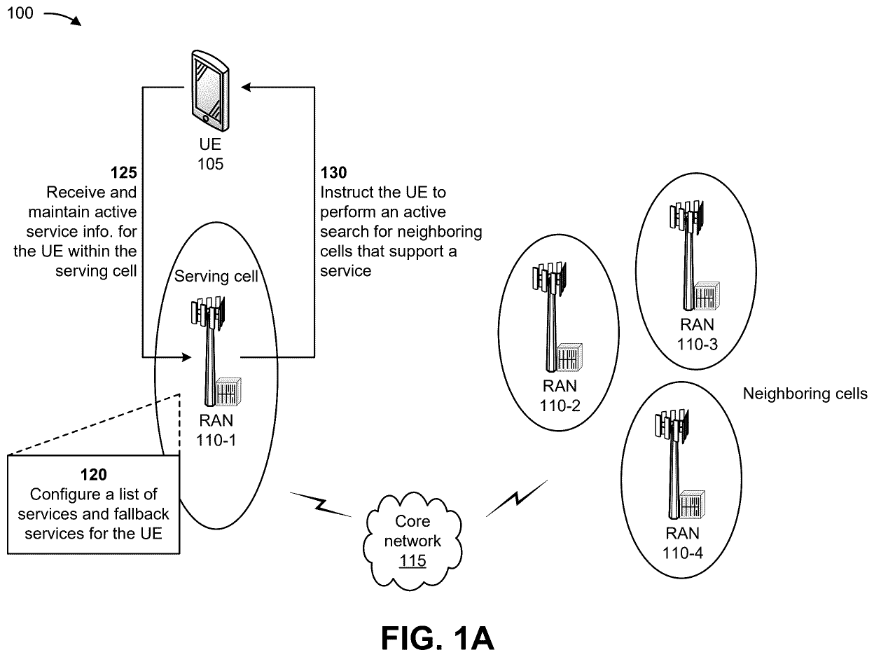

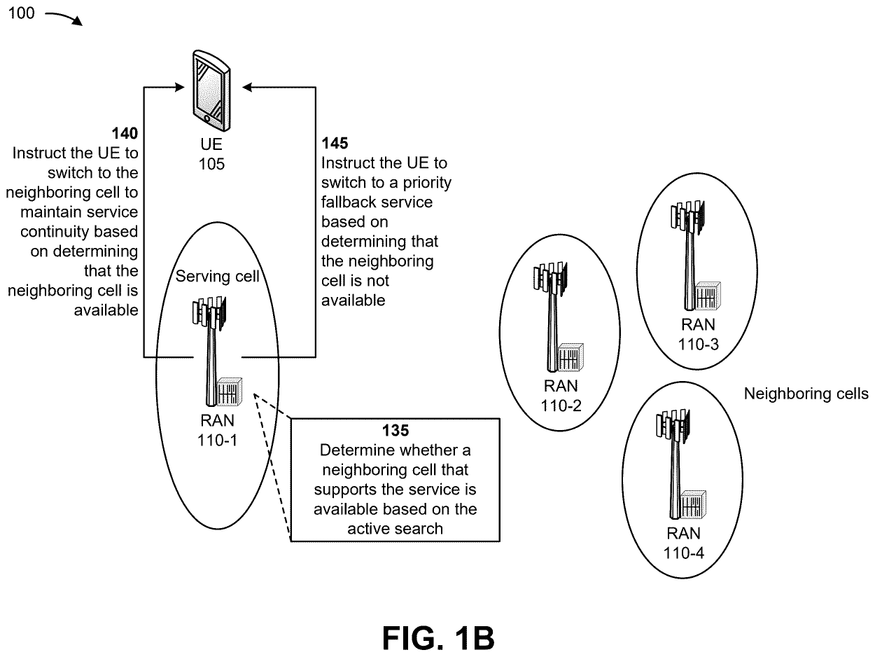

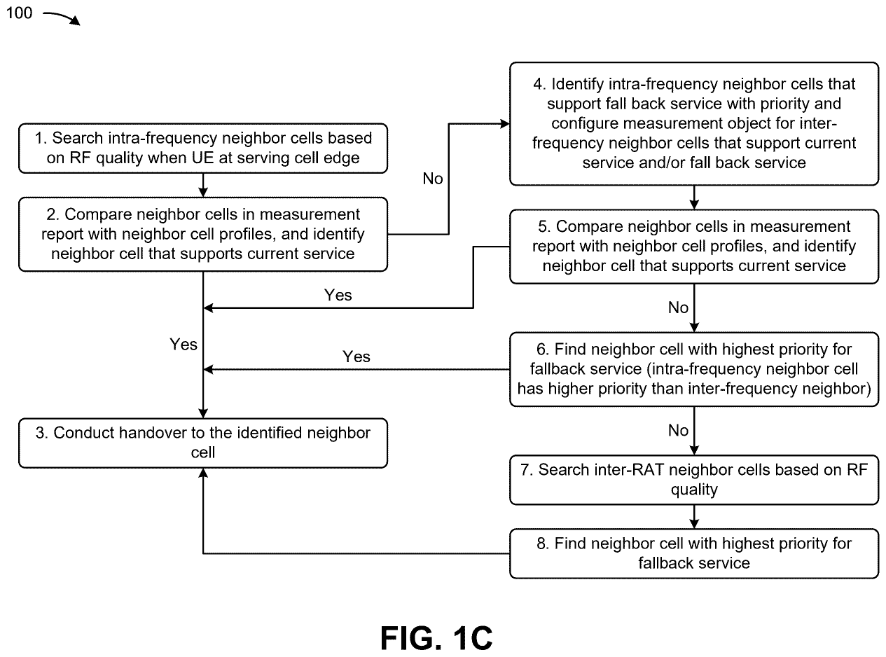

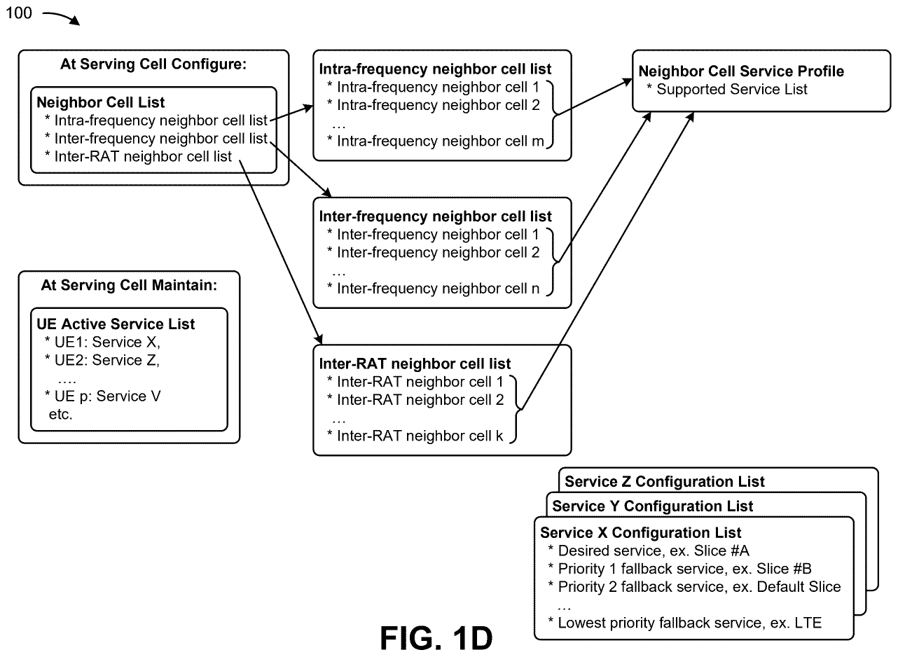

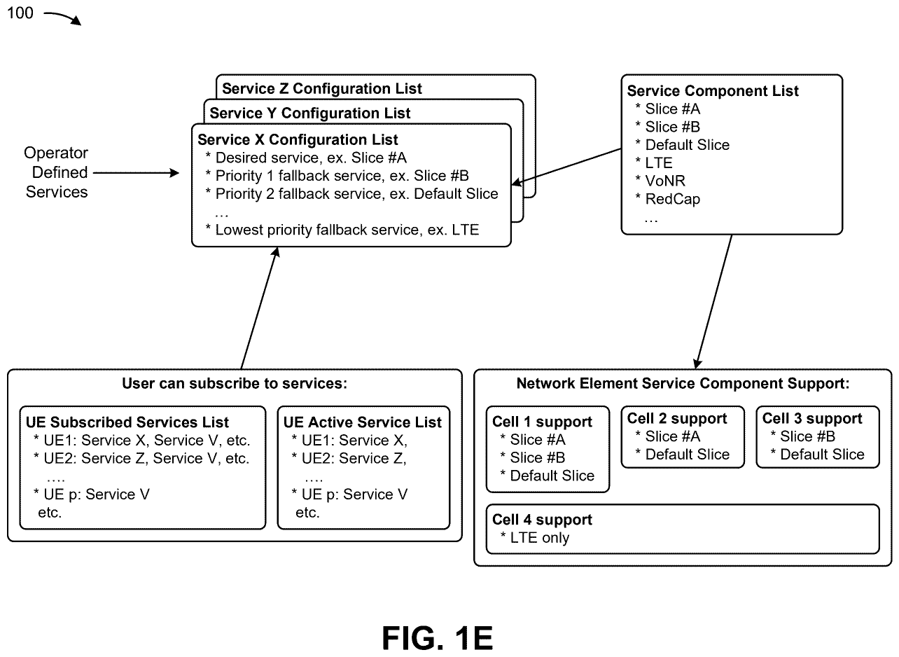

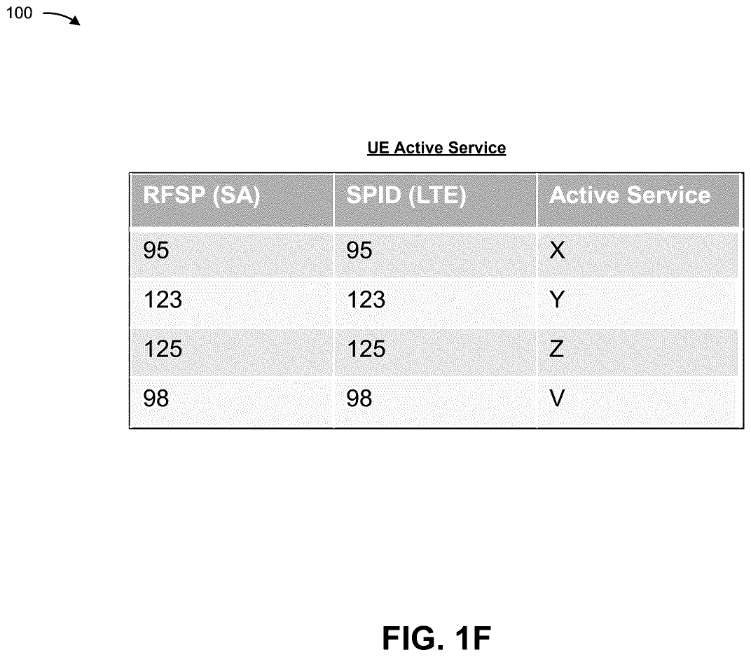

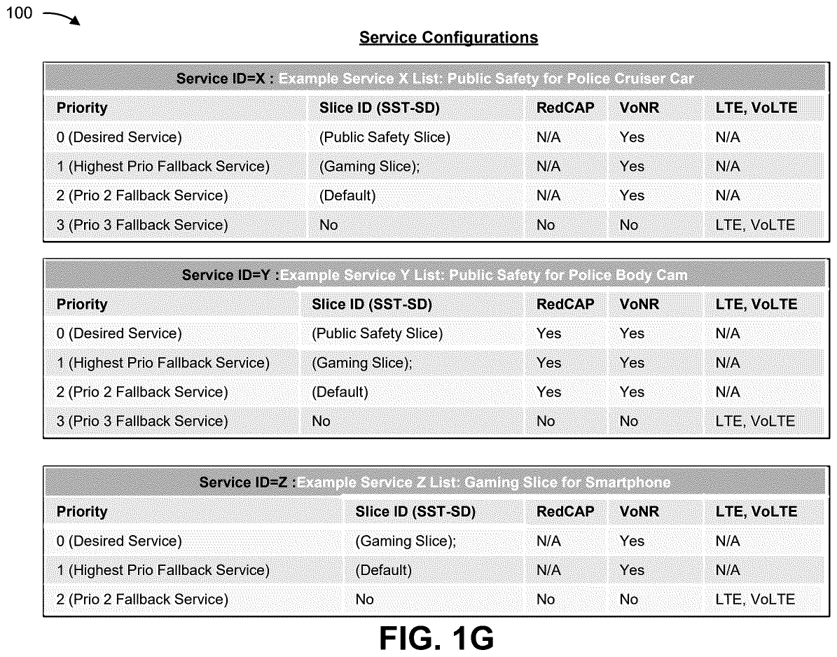

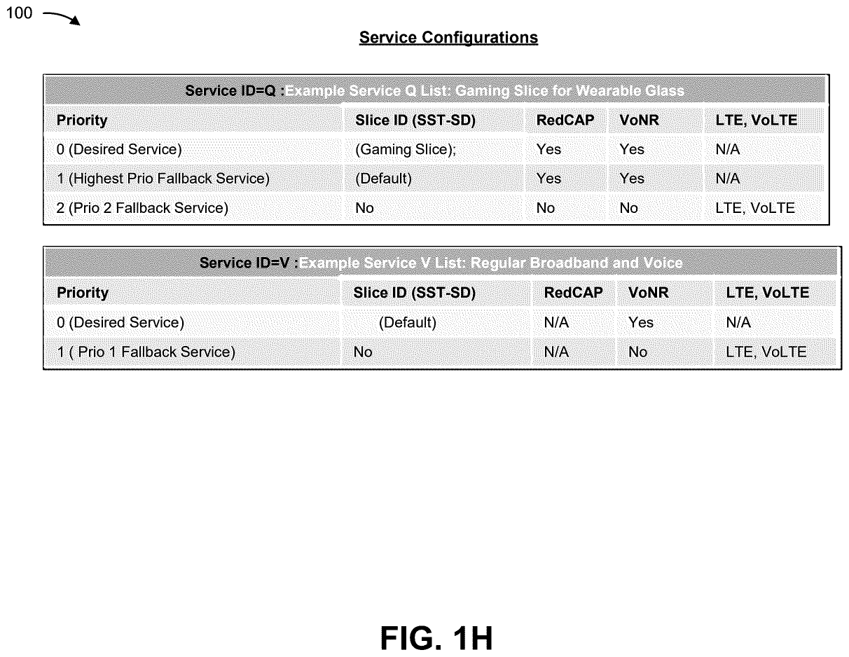

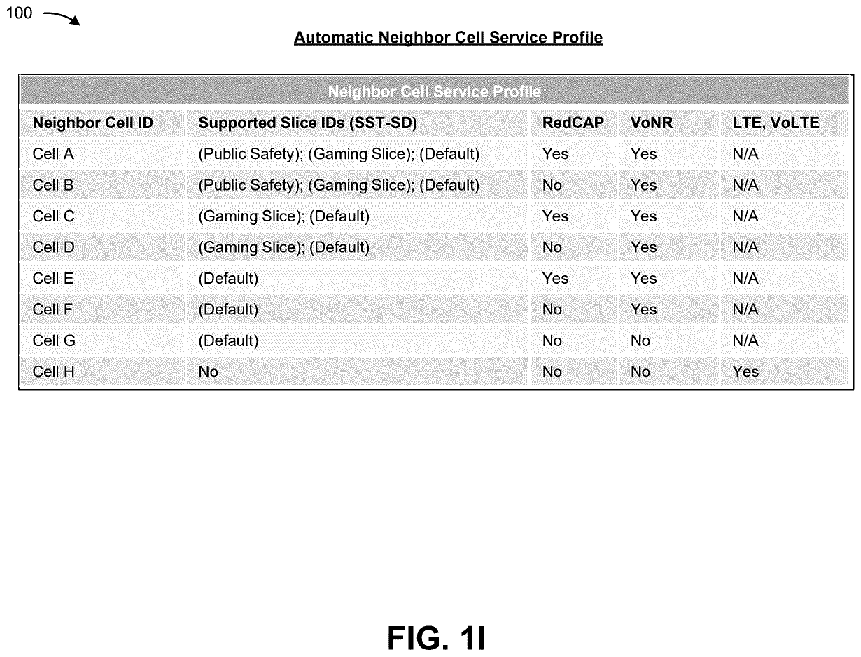

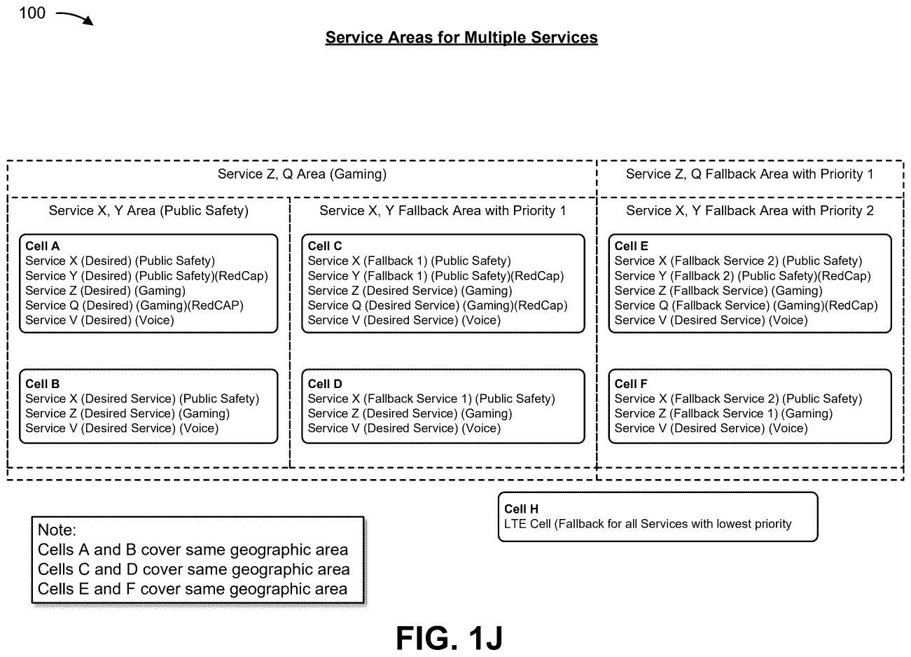

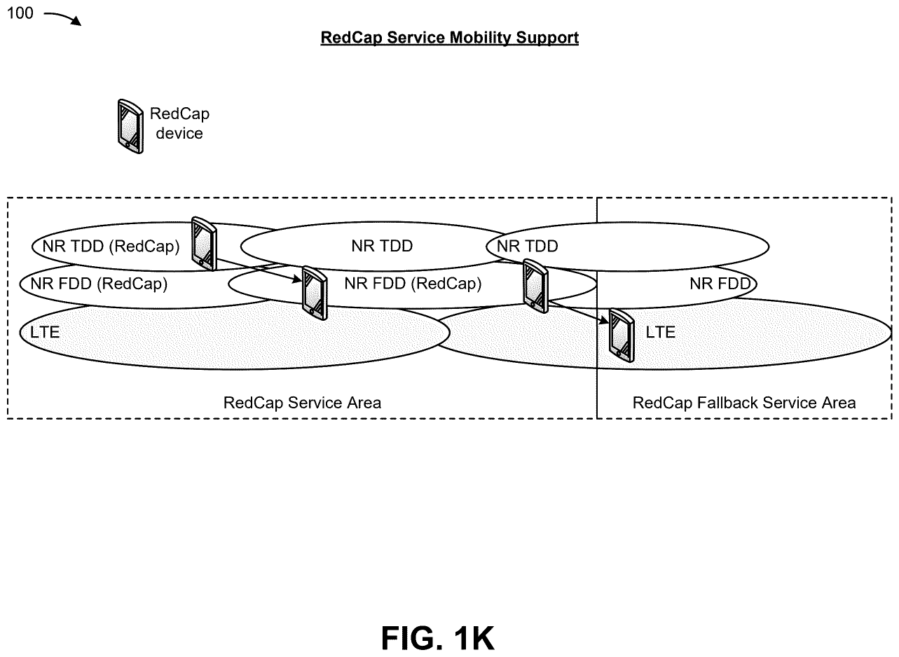

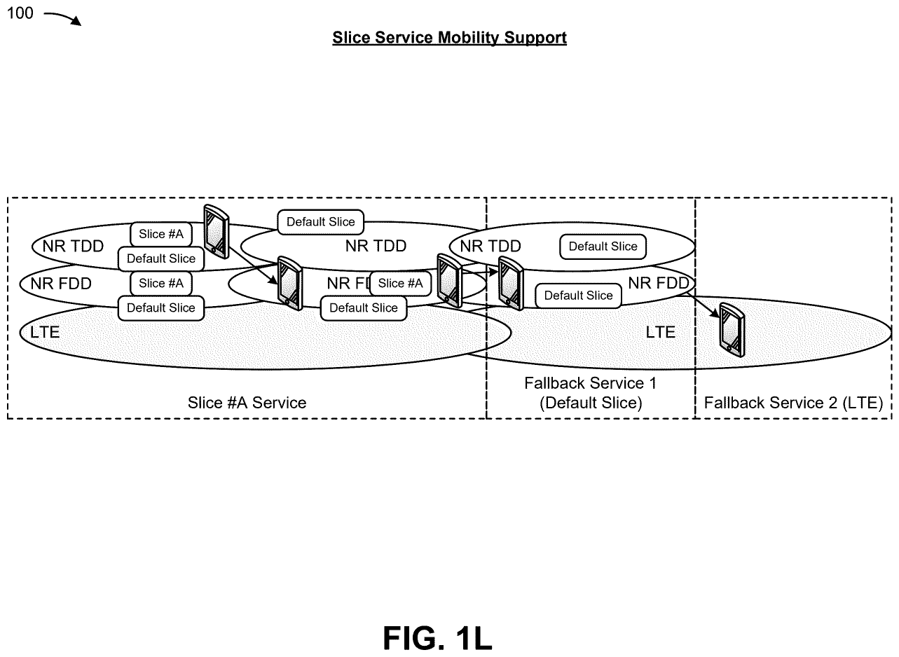

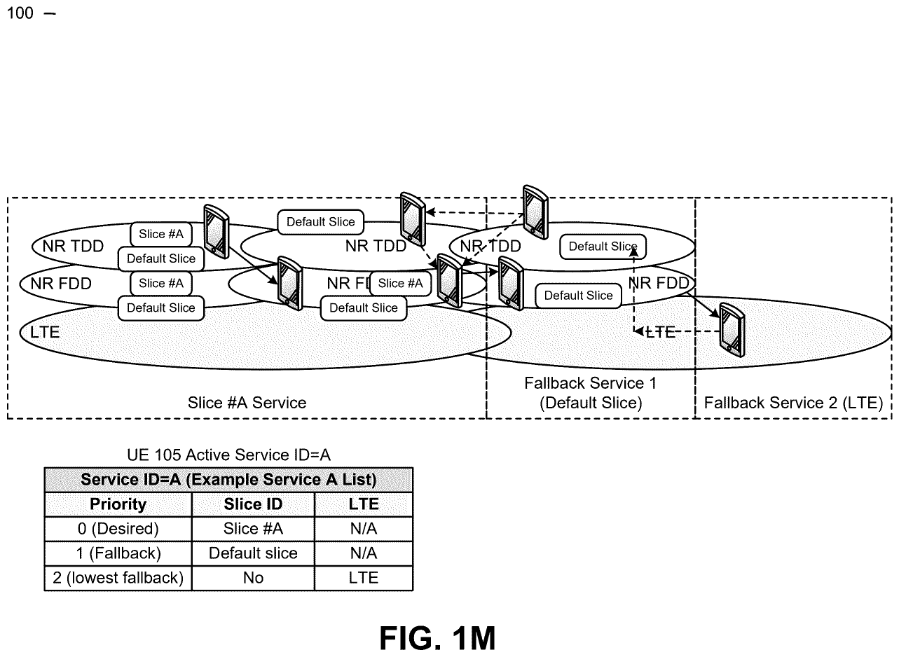

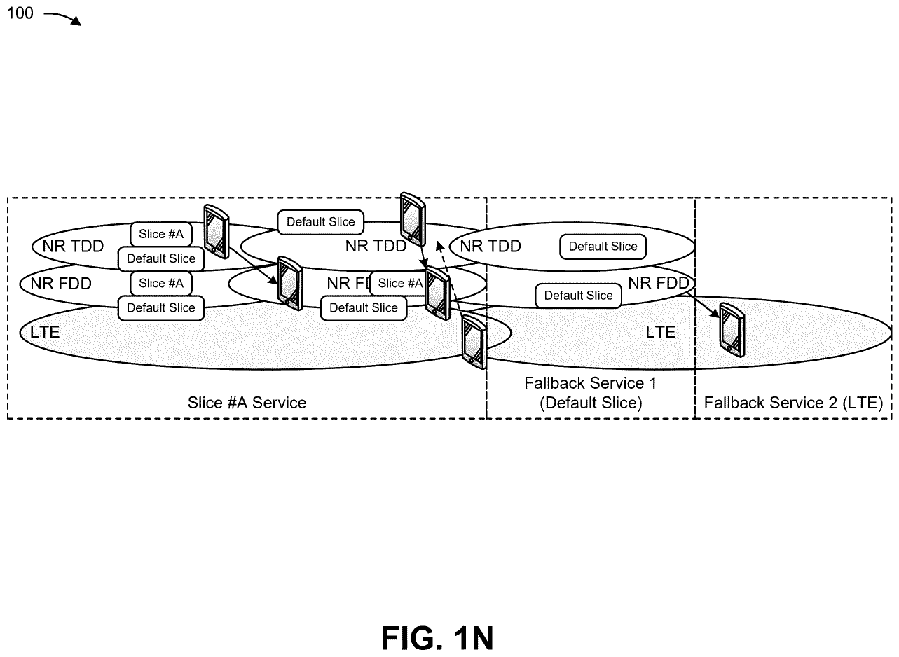

FIGS. 1A-1N are diagrams of an example 100 associated with providing RAN service continuity during UE mobility. As shown in FIG. 1A, the example 100 includes a UE 105, a first RAN 110-1 providing a serving cell, multiple RANs (e.g., a second RAN 110-2, a third RAN 110-3, and a fourth RAN 110-4) providing neighboring cells, and a core network 115. Further details of the UE 105, the RANs 110, the serving cell, the neighboring cells, the core network 115 are provided elsewhere herein.

As shown in FIG. 1A, and by reference number 120, the first RAN 110-1 may configure a list of services and fallback services for the UE 105 based on operator-defined services. For example, the first RAN 110-1 may compile a list that includes both desired services, such as voice-over-New-Radio (VoNR), network slices, reduced capability (RedCap), and/or the like, and fallback services with priorities, such as voice-over-Long-Term-Evolution (VoLTE), default network slices, Long Term Evolution (LTE), and/or the like. The list of services and fallback services may enable the first RAN 110-1 to identify and prioritize services based on various parameters. In some implementations, configuring the list of services and fallback services may include the first RAN 110-1 establishing a hierarchy of the services and the fallback services based on a location of the UE 105 and network conditions. This hierarchical approach may optimize service selection based on real-time conditions.

As further shown in FIG. 1A, and by reference number 125, the first RAN 110-1 may receive and maintain active service information for the UE 105 within the serving cell. For example, the first RAN 110-1 may obtain active service information through extended UE context information, radio access technology (RAT) frequency selection priority (RFSP) values, service profile identifier (SPID) values, target network slice selection assistance information (NSSAI), and/or the like. The active service information may enable the first RAN 110-1 to manage and maintain service continuity for the UE 105. Additionally, or alternatively, the first RAN 110-1 may continuously update the active service information based on movements the UE 105 and network changes to ensure accurate service management for the UE 105. Continuously updating the active service information may enable the first RAN 110-1 to adapt to dynamic network conditions.

As further shown in FIG. 1A, and by reference number 130, the first RAN 110-1 may instruct the UE 105 to perform an active search for neighboring cells that support a service. For example, the first RAN 110-1 may configure the UE 105 to search for inter-frequency or inter-RAT neighboring cells that support the service or prioritized fallback services. The active search by the UE 105 may ensure that the UE 105 can maintain service continuity as the UE 105 moves across different cells within the network. In some implementations, instructing the UE to perform the active search may include the first RAN 110-1 configuring the UE 105 to search for neighboring cells that support a current service or a highest priority fallback service through inter-frequency or inter-RAT measurements. The configuration may ensure that the UE 105 locates a best available service. Additionally, or alternatively, the first RAN 110-1 may instruct the UE 105 to dynamically adjust the search parameters for the active search based on real-time network conditions and service requirements to optimize service continuity. The dynamic adjustment of the search parameters may enable the first RAN 110-1 to adaptively manage the search process for improved outcomes.

As shown in FIG. 1B, and by reference number 135, the first RAN 110-1 may determine whether a neighboring cell that supports the service is available based on the active search. For example, the first RAN 110-1 may compare measurement reports (e.g., received from the UE 105) with profiles of the neighboring cells (e.g., the second RAN 110-2, the third RAN 110-3, and the fourth RAN 110-4) to determine whether a neighboring cell that supports the service is available based on comparing the measurement reports with the profiles. This may include the first RAN 110-1 evaluating signal strength, service compatibility, and other relevant metrics to identify a suitable neighboring cell that can maintain the service. In some implementations, the measurement results may be generated based on the active search conducted by the UE 105.

As further shown in FIG. 1B, and by reference number 140, the first RAN 110-1 may instruct the UE 105 to switch to the neighboring cell to maintain service continuity based on determining that the neighboring cell is available. For example, if the first RAN 110-1 determines that the neighboring cell that supports the service is available, the first RAN 110-1 may initiate an inter-frequency or intra-frequency handover process to transfer the UE 105 to the identified neighboring cell (e.g., the second RAN 110-2) to ensure uninterrupted service delivery. In some implementations, the first RAN 110-1 may instruct the UE 105 to switch to the neighboring cell by instructing the UE 105 to perform the inter-frequency or the intra-frequency handover process that transfers the UE 105 to the neighboring cell. The UE 105 may execute the inter-frequency or the intra-frequency handover to the neighboring cell based on the instruction from the first RAN 110-1.

As further shown in FIG. 1B, and by reference number 145, the first RAN 110-1 may, alternatively, instruct the UE 105 to switch to a priority fallback service based on determining that the neighboring cell is not available. For example, if the first RAN 110-1 determines that the neighboring cell that supports the service is not available, the first RAN 110-1 may configure the UE 105 to search for and switch to a fallback service with a highest priority available in the area. The fallback service may include VoLTE or another predefined fallback service, and reduce the impact on user experience and maintaining service continuity albeit at a different service level. In some implementations, the first RAN 110-1 may instruct the UE 105 to switch to the priority fallback service by configuring the UE 105 to identify and connect to the priority fallback service.

FIG. 1C depicts an example flow diagram associated with providing RAN service continuity during UE mobility. As shown at step 1, the RAN 110 (e.g., the first RAN 110-1) may search intra-frequency neighbor cells based on radio frequency (RF) quality when the UE 105 is at the serving cell edge. For example, the RAN 110 may analyze RF quality metrics for intra-frequency neighbor cells when the UE 105 is near the edge of the serving cell. Additionally, or alternatively, the RAN 110 may assess signal strength and quality of intra-frequency neighbor cells as the UE 105 moves to the serving cell boundary. Additionally, or alternatively, the RAN 110 may perform measurements of the RF quality of the intra-frequency neighbor cells when the UE 105 is at the edge of the serving cell coverage.

As shown at step 2, the RAN 110 may compare neighbor cells in a measurement report with neighbor cell profiles and may identify a neighbor cell that supports the current service based on the comparison. For example, the RAN 110 may compare measurement data (e.g., received from the UE 105) with stored profiles of the neighbor cells to identify a compatible neighbor cell supporting the current service provided to the UE 105.

As shown at step 3, the RAN 110 may conduct a handover to the identified neighbor cell. For example, if the RAN 110 identifies a compatible neighbor cell supporting the current service provided to the UE 105 (step 2—Yes), the RAN 110 may manage a handover to the identified neighbor cell to maintain service for the UE 105. Additionally, or alternatively, the RAN 110 may execute a handover protocol to transition the UE 105 to the identified neighbor cell supporting the current service.

As shown at step 4, if no intra-frequency neighbor cell that supports the current service is found, the RAN 110 may identify intra-frequency neighbor cells that support fallback services with priority and may configure measurement objects for inter-frequency neighbor cells that support the current service and/or fallback services. For example, if the RAN 110 fails to identify a compatible neighbor cell supporting the current service (step 2—No), the RAN 110 may configure the UE 105 to measure and provide reports on inter-frequency neighbor cells supporting the current service or fallback services.

As shown at step 5, the RAN 110 may again compare neighbor cells in a measurement report with neighbor cell profiles and may identify any neighbor cell that supports the current service. For example, the RAN 110 may re-evaluate measurement reports received from the UE 105 to identify a compatible neighbor cell for handover. Additionally, or alternatively, the RAN 110 may analyze the latest measurement data to identify a neighbor cell that can provide the current service. If the RAN 110 identifies a neighbor cell that can provide the current service (step 5—Yes), the RAN 110 may manage a handover to the identified neighbor cell to provide the current service for the UE 105 (step 3).

As shown at step 6, if no neighbor cell supporting the current service is identified (step 5—No), the RAN 110 may find the neighbor cell with the highest priority for fallback service (e.g., where intra-frequency neighbor cells have higher priority than inter-frequency neighbor cells). For example, the RAN 110 may apply predefined rules to rank fallback services and may identify the best available fallback service cell. Additionally, or alternatively, the RAN 110 may use priority guidelines to select the highest priority fallback service cell. Additionally, or alternatively, the RAN 110 may identify the most appropriate fallback service cell by prioritizing fallback options according to predefined criteria. If the RAN 110 identifies a neighbor cell with the highest priority for fallback service (step 6—Yes), the RAN 110 may manage a handover to the identified neighbor cell to provide the highest priority fallback service for the UE 105 (step 3).

As shown at step 7, if no intra-frequency fallback service neighbor cell is identified (step 6—No), the RAN 110 may search inter-RAT neighbor cells based on RF quality. For example, the RAN 110 may direct the UE 105 to assess and report on inter-RAT neighbor cells RF qualities. Additionally, or alternatively, the RAN 110 may request the UE 105 to gather measurements and provide data on inter-RAT neighbor cells.

As shown at step 8, the RAN 110 may find the neighbor cell with the highest priority for fallback service among the inter-RAT neighbor cells. For example, the RAN 110 may determine the inter-RAT neighbor cell with the highest priority fallback service for UE 105. The RAN 110 may manage a handover to the inter-RAT neighbor cell to provide the highest priority fallback service for the UE 105 (step 3).

FIG. 1D depicts examples of information that may be maintained by a serving cell RAN (e.g., the first RAN 110-1). As shown, the first RAN 110-1 may configure and maintain various lists to manage service continuity for the UE 105. In some implementations, the first RAN 110-1 may configure and maintain various lists to manage service continuity for the UE 105, including lists for intra-frequency, inter-frequency, and inter-RAT neighbor cells. These lists may facilitate efficient handover processes and service continuity by identifying potential target cells supporting either the same or different radio access technologies. Additionally, or alternatively, the first RAN 110-1 may manage active service information via extended UE context information or other formats, such as RFSP, SPID, or target NSSAI. These formats may enable the first RAN 110-1 to maintain comprehensive information about the active services and preferences of the UE 105, aiding in decision-making for handovers and service continuity.

As further shown in FIG. 1D, the first RAN 110-1 may maintain a UE active service list. In some implementations, the first RAN 110-1 may maintain active service lists for each UE 105 within the serving cell, and may track services (e.g., Service X, Service Z, and Service V). Tracking the services may ensure that the first RAN 110-1 can accurately monitor and manage the services required by each UE 105, facilitating smooth transitions and maintaining service quality.

As further shown in FIG. 1D, the first RAN 110-1 may configure and maintain an intra-frequency neighbor cell list. In some implementations, the first RAN 110-1 may configure and maintain the intra-frequency neighbor cell list to manage handovers when the UE 105 moves to the edge of the serving cell coverage. This list may include cells operating on the same frequency, allowing seamless handovers without changing the frequency, which can help maintain consistent service quality.

As further shown in FIG. 1D, the first RAN 110-1 may configure and maintain an inter-frequency neighbor cell list. In some implementations, the first RAN 110-1 may configure and maintain the inter-frequency neighbor cell list for use when no suitable intra-frequency neighbor cell is available. These cells, operating on different frequencies, may provide alternative handover options, ensuring that the UE 105 can always find a suitable cell to connect to, even when intra-frequency options are limited.

As further shown in FIG. 1D, the first RAN 110-1 may configure and maintain an inter-RAT neighbor cell list. In some implementations, the first RAN 110-1 may configure and maintain the inter-RAT neighbor cell list for use when neither intra-frequency nor inter-frequency cells are suitable. This list may identify cells using different radio access technologies, offering further alternatives to support the continuous connection of the UE 105.

As further shown in FIG. 1D, the first RAN 110-1 may maintain a neighbor cell service profile. In some implementations, the first RAN 110-1 may maintain the neighbor cell service profile to keep track of the services supported by each neighboring cell for informed handover management. This information may enable the first RAN 110-1 to make strategic decisions about handovers, selecting cells that best meet the current service needs of the UE 105.

As further shown in FIG. 1D, the first RAN 110-1 may configure service configuration lists for various services, such as Service X, Service Y, and Service Z. For example, the Service X configuration list may include details of a desired service (e.g., slice #A), priority fallback services (e.g., slice #B and a default slice), and the lowest priority fallback service (e.g., LTE). These configuration lists may enable the first RAN 110-1 to prioritize and manage service continuity for different services provided to the UE 105.

FIG. 1E depicts an example architecture associated with providing RAN service continuity during UE mobility. As shown, the architecture may include operator-defined services, service configuration lists, service component lists, UE subscribed service lists, UE active service lists, and network element service component support. The operator-defined services may be configured into various service configuration lists, such as Service X configuration list, Service Y configuration list, and Service Z configuration list. Each service configuration list may include a desired service and a hierarchy of fallback services. For example, the Service X configuration list may include a desired service (e.g., slice #A), a priority fallback service (e.g., slice #B), and a lowest priority fallback service (e.g., LTE). In some implementations, the service configuration lists may be dynamically adjusted to reflect changes in service availability and priority, ensuring optimal service delivery. For example, if a VoNR service becomes less reliable, the RAN 110 may dynamically update to prioritize LTE and other services accordingly.

The service component list may enumerate various service components, such as slice #A, slice #B, default slice, LTE, VoNR, and RedCap. These service components may support different services and fallback services as defined in the service configuration lists. In some implementations, the service component list may be periodically updated to reflect changes in network infrastructure and service capabilities. For example, new slices or technologies may be added in response to network upgrades or changes in service demands. In some implementations, the architecture may include a centralized data repository for storing and retrieving the service configuration lists and the service component list. Such a data repository may efficiently manage and update service-related data across the network.

The UE subscribed services list may record the services to which each UE 105 subscribes, such as Service X, Service V, Service Z, and/or the like. Similarly, the UE active service list may maintain the active services for each UE 105, ensuring that the RAN 110 can monitor and manage these services effectively. For example, a UE 105 may subscribe to Service A and Service B and may actively receive Service A. Additionally, or alternatively, the architecture may include mechanisms for real-time monitoring and management of UE service activity to ensure continuous service delivery. This may include continuously tracking active services and making necessary adjustments to maintain service quality. Additionally, or alternatively, the architecture may facilitate seamless service transition by leveraging predefined service profiles and maintaining comprehensive service subscription and activity logs for each UE 105. For example, service transitions can be managed based on the predefined profiles ensuring no disruption occurs.

The network element service component support may include the service components supported by each cell. For example, cell 1 may support slice #A, slice #B, and a default slice; cell 2 may support slice #A and the default slice; cell 3 may support slice #B and the default slice; and cell 4 may support LTE only. This information may aide the RAN 110 in making strategic decisions about handovers and service continuity for the UEs 105. The network element service component support information may be used to optimize resource allocation and improve overall network efficiency. For example, resources may be dynamically reallocated to cells supporting high-priority services based on current conditions. Additionally, or alternatively, the architecture may support automated decision-making processes for service handovers based on the predefined service profiles and real-time network conditions. Such automation may ensure that services are consistently and reliably maintained without manual intervention.

FIG. 1F depicts example active services that may be provided to the UE 105. As shown, a UE active service list may define UE active services via an RFSP/SPID values. The UE active service list may include mappings between an RFSP (SA) value, an SPID (LTE) value, and an active service. For example, the mappings may include RFSP and SPID values of “95” corresponding to active service X. Active service X may represent a specific service such as VoNR or a network slice designed for a particular use case. The mappings may include RFSP and SPID values of “123” corresponding to active service Y, a priority fallback service. Active service Y may represent a different service, such as a priority fallback service for VoNR. The mappings may include RFSP and SPID values of “125” corresponding to active service Z, such as a RedCap service. Active service Z may offer specialized support for devices with limited functionality. The mappings may include RFSP and SPID values of “98” corresponding to active service V, which could represent a default service. Active service V may be a basic connectivity service provided to the UE 105 under standard conditions. These mappings allow the RAN to effectively monitor and manage the active services of the UE 105, ensuring seamless transitions and service continuity. Alternatively, the active service list may be added in UE context information, may be provided in a target NSSAI of UE context information, and/or the like.

FIGS. 1G and 1H depict example service configurations capable of being maintained by RANs 110, such as the first RAN 110-1. As shown in FIG. 1G, the RAN 110-1 may configure service lists for various services, such as a public safety service list for a police cruiser car (e.g., Service ID=X), a public safety service list for a police body camera (e.g., Service ID=Y), and a gaming service list for a smartphone (e.g., Service ID=Z). In some implementations, the service configurations may include a public safety service list for an ambulance (e.g., Service ID=A). This may involve configuring priority services specifically catered for emergency response and patient care devices. Additionally, or alternatively, the RAN 110-1 may configure a media streaming service list for a tablet (e.g., Service ID=B). This configuration may prioritize high-bandwidth services for uninterrupted media streaming. Additionally, or alternatively, the RAN 110-1 may configure an industrial Internet of Things (IoT) service list for a factory robot (e.g., Service ID=C). This may include ensuring low-latency and highly reliable communication for industrial automation.

As shown in FIG. 1G, the service configurations may include a priority hierarchy of desired services and fallback services. For example, Service ID=X may include a desired service of a public safety slice, with fallback services including a gaming slice as the highest priority fallback, a default service as the second priority, and LTE/VoLTE as the third priority fallback. Similarly, Service ID=Y may include a public safety slice as the desired service, with fallback services prioritized as a gaming slice and a default service, and LTE/VoLTE as the last fallback. Service ID=Z may include a gaming slice as the desired service with a default service as the highest priority fallback and LTE/VoLTE as the second priority fallback.

In some implementations, Service ID=A may include a desired service of a critical emergency slice, with fallback services including a medical data slice as the highest priority fallback. Additionally, or alternatively, Service ID=B may include a media streaming slice as the desired service, with fallback services prioritized as a high-definition video slice. This may ensure seamless video quality even when the preferred service is unavailable. Additionally, or alternatively, Service ID=C may include an industrial control slice as the desired service, with a machine-to-machine communication slice as the highest priority fallback. This may maintain high performance in industrial automation environments.

As shown in FIG. 1H, the RAN 110-1 may configure service lists for various services, such as a gaming slice service for wearable glasses (e.g., Service ID=Q), and a regular broadband and voice service (e.g., Service ID=V). The service configurations may include a priority hierarchy of desired services and fallback services. For example, Service ID=Q may include a desired service of a gaming slice, with fallback services including a default service as the highest priority and no slice as the second priority fallback. Similarly, Service ID=V may include a default slice as the desired service, and no slice as a fallback service.

In some implementations, the fallback services may be prioritized based on predefined rules, allowing the RAN 110 to manage the transition between services effectively. Predefined rules may ensure a structured approach to prioritizing fallback services, enhancing decision-making. Additionally, or alternatively, in cases where no fallback services are available, the UE 105 may be instructed to switch to the next best available technology, such as LTE or VoLTE. This ensures that the UE 105 maintains some level of service even when primary and fallback services are unavailable.

In some implementations, the service configurations may be dynamically adjusted to reflect changes in service availability and priority, ensuring optimal service delivery. For example, if a VoNR service becomes less reliable, the RAN 110-1 may dynamically update to prioritize LTE and other services accordingly. Additionally, or alternatively, the RAN 110-1 may configure and maintain these service configuration lists to manage and prioritize services provided to the UE 105, facilitating seamless transitions and maintaining service quality. In some implementations, the service configurations may be dynamically adjusted based on real-time data. This allows the RAN 110-1 to react promptly to network changes and maintain optimal performance. Additionally, or alternatively, the RAN 110-1 may maintain the service configurations to handle varying service needs of different UEs 105 and scenarios efficiently.

FIG. 1I depicts an example automatic neighbor cell service profile capable being maintained by a serving cell RAN (e.g., the first RAN 110-1). For example, the first RAN 110-1 may configure and maintain a neighbor cell service profile that includes neighbor cell IDs and supported service slice IDs (SST-SD). The neighbor cell service profile may indicate whether each neighbor cell supports specific services, such as RedCap, VoNR, LTE, and VoLTE.

In some implementations, the neighbor cell service profile may identify specific cells, such as cell A, cell B, cell C, cell D, cell E, cell F, cell G, and cell H. For example, cell A may support public safety services, a gaming slice, and default services, along with RedCap and VoNR, but not LTE/VoLTE. Cell B may support public safety services, a gaming slice, and default services, along with VoNR but not RedCap or LTE/VoLTE. Cell C may support a gaming slice and default services, along with RedCap and VoNR but not LTE/VoLTE. Cell D may support a gaming slice and default services, along with VoNR but not RedCap or LTE/VoLTE. Cell E may support only default services, along with RedCap and VoNR but not LTE/VoLTE. Cell F may support only default services, along with VoNR but not RedCap or LTE/VoLTE. Cell G may support only default services, without RedCap, VoNR, or LTE/VoLTE. Cell H may support no other services except LTE/VoLTE.

By maintaining such a neighbor cell service profile, the first RAN 110-1 can facilitate efficient handover processes and ensure service continuity by identifying potential target cells that support the desired services. This profile may aid in making informed decisions regarding handover management, optimizing service delivery, and enhancing user experience by ensuring that the UE 105 can always connect to a cell that supports its active or fallback services.

FIG. 1J provides examples multiple services capable of being provided by RAN service areas. As shown, the service areas may include different cells supporting various services and fallback services. For example, cell A may support Service X, Service Y, Service Z, Service Q, and Service V. Cell A may provide the desired public safety service (Service X), the desired public safety and RedCap service (Service Y), the desired gaming service (Service Z), the desired gaming and RedCap service (Service Q), and the desired voice service (Service V). Cell A may also support services such as VoNR, RedCap, and default slices, offering desired services for different use cases.

Cell B may support Service X, Service Z, and Service V, offering the desired public safety service (Service X), the desired gaming service (Service Z), and the desired voice service (Service V). Cell B may support a combination of desired services for gaming and public safety, ensuring service continuity for users engaged in these activities.

Cell C may support fallback services including Service X (Public Safety), Service Y (Public Safety/RedCap), Service Z (Gaming), Service Q (Gaming/RedCap), and Service V (Voice). Specifically, cell C provides fallback 1 for public safety (Service X), fallback 1 for public safety and RedCap (Service Y), the desired gaming service (Service Z), the desired gaming and RedCap service (Service Q), and the desired voice service (Service V). Cell C may provide fallback services prioritized based on predefined rules, ensuring minimal disruption to ongoing services like public safety and gaming.

Similarly, cell D may support fallback services including Service X, Service Z, and Service V in the same capacity as Cell C, providing fallback 1 for public safety, public safety and RedCap, gaming, gaming and RedCap, and voice, respectively. Cell D may operate similarly to cell C, ensuring that fallback services are available to maintain continuity for critical services.

Cell E may support fallback services with lower priority, including Service X (Public Safety), Service Y (Public Safety/RedCap), Service Z (Gaming), Service Q (Gaming/RedCap), and Service V (Voice). Specifically, cell E provides fallback 2 for public safety (Service X), fallback 2 for public safety and RedCap (Service Y), the gaming fallback service (Service Z), the gaming and RedCap fallback (Service Q), and the desired voice service (Service V). Cell E may offer lower priority fallback services, ensuring that users have access to essential services like voice and gaming even in less optimal conditions.

Cell F may support fallback services including Service X, Service Z, and Service V in the same capacity as cell E. Specifically, cell F provides fallback 2 for public safety (Service X), the gaming fallback service (Service Z), and the voice fallback service (Service V). Cell F may mirror the fallback service offerings of cell E, ensuring redundancy and reliability in the network's service delivery.

Lastly, cell H may support LTE as a fallback for all services with the lowest priority. Cell H may act as a fallback for all services in the LTE network, providing a basic level of service continuity when higher priority services are unavailable.

FIG. 1K depicts an example of providing service mobility support for a RedCap device. For example, the RedCap device may initially operate within a RedCap service area, which includes New Radio (NR) time division duplex (TDD) and NR frequency division duplex (FDD) cells that support the RedCap service. When the RedCap device moves towards a neighboring NR TDD cell that does not support the RedCap service, the network (e.g., a RAN 110) may configure the RedCap device to conduct an inter-frequency neighbor search. This search may enable the RedCap device to find a neighboring NR FDD cell that supports the RedCap service. The RedCap device may then perform an inter-frequency handover to the NR FDD cell to continue receiving the RedCap service.

If the RedCap device moves further and leaves the RedCap service area, the RedCap device may enter a RedCap fallback service area. In this case, the RAN 110 may configure the RedCap device to search for fallback services. For example, the RAN 110 may instruct the RedCap device to search for inter-RAT neighbor cells that support fallback services, such as LTE. The RedCap device may then perform an inter-RAT handover to an LTE cell to maintain service continuity.

FIGS. 1L and 1M depict examples of providing service mobility support for network slices. As shown in FIG. 1L, a UE 105 initially operating within a slice #A service area, which includes NR TDD and NR FDD cells supporting slice #A and default slices, may move towards a neighboring NR TDD cell that does not support slice #A. The network (e.g., a RAN 110) may configure the UE 105 to conduct an inter-frequency neighbor search. The search may enable the UE 105 to locate a neighboring NR FDD cell that supports slice #A. The UE 105 may then perform an inter-frequency handover to the NR FDD cell to continue receiving slice #A service.

As the UE 105 continues to move and exits the slice #A service area, the UE 105 may enter a fallback service 1 (default slice) area. In this case, the RAN 110 may configure the UE 105 to search for fallback services with high priority. For example, the RAN 110 may instruct the UE 105 to search for inter-frequency neighboring cells that support the default slice service. The UE 105 may then perform an inter-frequency handover to a default slice supporting cell to maintain service continuity.

If the UE 105 moves further and leaves the fallback service 1 (default slice) area, the UE 105 may enter a fallback service 2 (LTE) area. The RAN 110 may then configure the UE 105 to search for LTE fallback services. For example, the RAN 110 may instruct the UE 105 to search for inter-RAT neighboring cells that support LTE. The UE 105 may then perform an inter-RAT handover to an LTE cell to maintain service continuity.

As shown in FIG. 1M, the UE 105 may move from the fallback service 2 (LTE) area towards the NR TDD cell of the fallback service 1 (default slice) area, and the RAN 110 may configure the UE 105 to conduct an inter-frequency neighbor search. The search may enable the UE 105 to locate a neighboring NR TDD cell that supports the default slice. The UE 105 may then perform an inter-RAT handover to the NR TDD cell of the fallback service 1 (default slice) area.

As further shown in FIG. 1M, the UE 105 may continue to move from the fallback service 1 (default slice) area and may enter the NR TDD cell of the slice #A service area. Since the service cell maintains UE active service information (e.g., active service ID=A for the UE 105), even though the UE 105 is on the default slice in the serving RAN 110, the serving RAN 110 may include the desired service information for the UE 105 (e.g., slice #A). In this case, the RAN 110 may configure the UE 105 to conduct an inter-frequency neighbor search. The search may enable the UE 105 to locate a neighboring NR FDD cell that supports slice #A. The UE 105 may then perform an inter-frequency handover to the NR FDD cell to receive slice #A service.

FIG. 1N depicts an example of providing service setup support for network slices. For example, the RAN 110 may configure a UE 105 to conduct an inter-frequency neighbor search when the UE 105 is idle on an NR TDD cell that supports only a default slice while attempting to set up a service, such as slice #A. The NR TDD cell may reject the service setup request for slice #A, and subsequently, the RAN 110 may configure the UE 105 to search for a neighboring NR FDD cell that supports slice #A. The UE 105 may then perform an inter-frequency handover to the neighboring NR FDD cell and successfully set up the slice #A service. This procedure ensures that the UE 105 can access the desired service even if the initial serving cell does not support it.

In this way, the RAN 110 provides RAN service continuity during UE 105 mobility. For example, the RAN 110 may enhance mobility support to improve service delivery across non-homogeneous deployment in a 5G SA network. The RAN 110 may configure a list of services and fallback services for a UE 105 based on various parameters. The RAN 110 may maintain active service information for the UE 105 within the serving cell, which can be received through extended UE context information. The RAN 110 may instruct the UE 105 to perform an active search for neighboring cells that support a service and may determine the availability of the neighboring cells based on the active search performed by the UE 105. Based on the determination, the RAN 110 may instruct the UE 105 to either switch to the neighboring cell to maintain service continuity for the service or switch to a priority fallback service if the service is not available. Thus, the RAN 110 may conserve computing resources, networking resources, and/or other resources that would have otherwise been consumed by failing to provide a continuous service to a mobile UE 105, handling degradation of the service for a mobile UE 105, handling customer complaints associated with the degradation of the service, and/or the like.

As indicated above, FIGS. 1A-1N are provided as an example. Other examples may differ from what is described with regard to FIGS. 1A-1N. The number and arrangement of devices shown in FIGS. 1A-1N are provided as an example. In practice, there may be additional devices, fewer devices, different devices, or differently arranged devices than those shown in FIGS. 1A-1N. Furthermore, two or more devices shown in FIGS. 1A-1N may be implemented within a single device, or a single device shown in FIGS. 1A-1N may be implemented as multiple, distributed devices. Additionally, or alternatively, a set of devices (e.g., one or more devices) shown in FIGS. 1A-1N may perform one or more functions described as being performed by another set of devices shown in FIGS. 1A-1N.

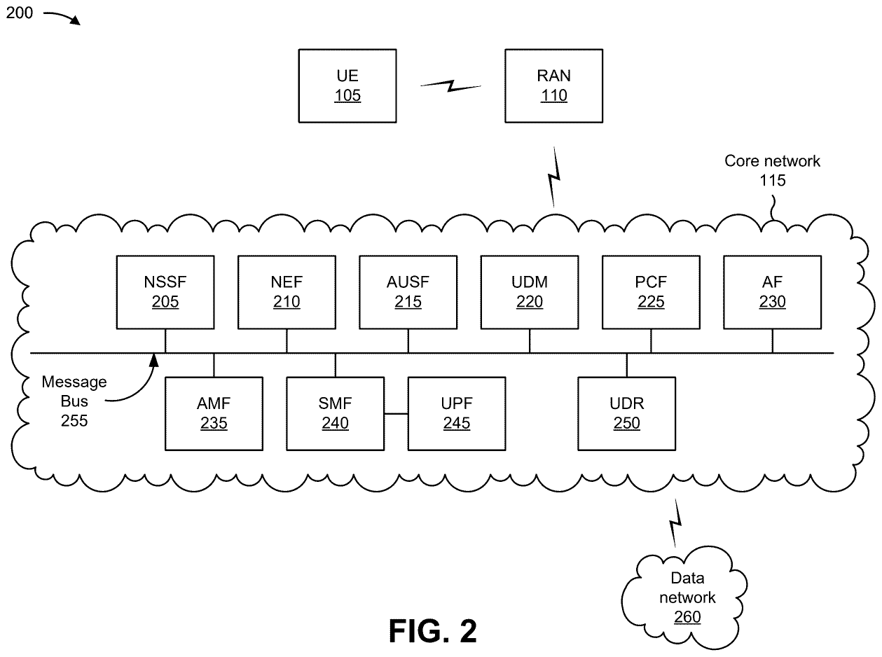

FIG. 2 is a diagram of an example environment 200 in which systems and/or methods described herein may be implemented. As shown in FIG. 2, the example environment 200 may include the UE 105, the RAN 110, the core network 115, and a data network 260. Devices and/or networks of the example environment 200 may interconnect via wired connections, wireless connections, or a combination of wired and wireless connections.

The UE 105 includes one or more devices capable of receiving, generating, storing, processing, and/or providing information, such as information described herein. For example, the UE 105 can include a mobile phone (e.g., a smart phone or a radiotelephone), a laptop computer, a tablet computer, a desktop computer, a handheld computer, a gaming device, a wearable communication device (e.g., a smart watch or a pair of smart glasses), a mobile hotspot device, a fixed wireless access device, customer premises equipment, an autonomous vehicle, or a similar type of device.

The RAN 110 may support, for example, a cellular RAT. The RAN 110 may include one or more base stations (e.g., base transceiver stations, radio base stations, node Bs, eNodeBs (eNBs), gNodeBs (gNBs), base station subsystems, cellular sites, cellular towers, access points, transmit receive points (TRPs), radio access nodes, macrocell base stations, microcell base stations, picocell base stations, femtocell base stations, or similar types of devices) and other network entities that can support wireless communication for the UE 105. The RAN 110 may transfer traffic between the UE 105 (e.g., using a cellular RAT), one or more base stations (e.g., using a wireless interface or a backhaul interface, such as a wired backhaul interface), and/or the core network 115. The RAN 110 may provide one or more cells that cover geographic areas.

In some implementations, the RAN 110 may perform scheduling and/or resource management for the UE 105 covered by the RAN 110 (e.g., the UE 105 covered by a cell provided by the RAN 110). In some implementations, the RAN 110 may be controlled or coordinated by a network controller, which may perform load balancing, network-level configuration, and/or other operations. The network controller may communicate with the RAN 110 via a wireless or wireline backhaul. In some implementations, the RAN 110 may include a network controller, a self-organizing network (SON) module or component, or a similar module or component. In other words, the RAN 110 may perform network control, scheduling, and/or network management functions (e.g., for uplink, downlink, and/or sidelink communications of the UE 105 covered by the RAN 110).

In some implementations, the core network 115 may include an example functional architecture in which systems and/or methods described herein may be implemented. For example, the core network 115 may include an example architecture of a 5G Next Generation (NG) core network included in a 5G wireless telecommunications system. While the example architecture of the core network 115 shown in FIG. 2 may be an example of a service-based architecture, in some implementations, the core network 115 may be implemented as a reference-point architecture and/or a 4G core network, among other examples.

As shown in FIG. 2, the core network 115 may include a number of functional elements. The functional elements may include, for example, a network slice selection function (NSSF) 205, a network exposure function (NEF) 210, an authentication server function (AUSF) 215, a unified data management function (UDM) 220, a policy control function (PCF) 225, an application function (AF) 230, an access and mobility management function (AMF) 235, a session management function (SMF) 240, a user plane function (UPF) 245, and/or a unified data repository (UDR) 250. These functional elements may be communicatively connected via a message bus 255. Each of the functional elements shown in FIG. 2 is implemented on one or more devices associated with a wireless telecommunications system. In some implementations, one or more of the functional elements may be implemented on physical devices, such as an access point, a base station, and/or a gateway. In some implementations, one or more of the functional elements may be implemented on a computing device of a cloud computing environment.

The NSSF 205 includes one or more devices that select network slice instances for the UE 105. By providing network slicing, the NSSF 205 allows an operator to deploy multiple substantially independent end-to-end networks potentially with the same infrastructure. In some implementations, each slice may be customized for different services.

The NEF 210 includes one or more devices that support exposure of capabilities and/or events in the wireless telecommunications system to help other entities in the wireless telecommunications system discover network services.

The AUSF 215 includes one or more devices that act as an authentication server and support the process of authenticating the UE 105 in the wireless telecommunications system.

The UDM 220 includes one or more devices that store user data and profiles in the wireless telecommunications system. The UDM 220 may be used for fixed access and/or mobile access in the core network 115.

The PCF 225 includes one or more devices that provide a policy framework that incorporates network slicing, roaming, packet processing, and/or mobility management, among other examples.

The AF 230 includes one or more devices that support application influence on traffic routing, access to the NEF 210, and/or policy control, among other examples.

The AMF 235 includes one or more devices that act as a termination point for non-access stratum (NAS) signaling and/or mobility management, among other examples.

The SMF 240 includes one or more devices that support the establishment, modification, and release of communication sessions in the wireless telecommunications system. For example, the SMF 240 may configure traffic steering policies at the UPF 245 and/or may enforce user equipment Internet protocol (IP) address allocation and policies, among other examples.

The UPF 245 includes one or more devices that serve as an anchor point for intraRAT and/or interRAT mobility. The UPF 245 may apply rules to packets, such as rules pertaining to packet routing, traffic reporting, and/or handling user plane QoS, among other examples.

The UDR 250 includes one or more devices that store and manage data relevant to subscribers and network functions, such as user subscription information, policy data, and session context. The UDR 250 acts as a unified and centralized database that various network functions can access. The UDM 220 may retrieve subscription data from the UDR 250 during user authentication, mobility, and access management procedures. The PCF 225 may refer to the UDR 250 to get policy rules when enforcing policies for data sessions. The SMF 240 may access the UDR 250 for session-related data to manage and maintain user sessions effectively.

The message bus 255 represents a communication structure for communication among the functional elements. In other words, the message bus 255 may permit communication between two or more functional elements.

The data network 260 includes one or more wired and/or wireless data networks. For example, the data network 260 may include an IP Multimedia Subsystem (IMS), a public land mobile network (PLMN), a local area network (LAN), a wide area network (WAN), a metropolitan area network (MAN), a private network such as a corporate intranet, an ad hoc network, the Internet, a fiber optic-based network, a cloud computing network, a third-party services network, an operator services network, and/or a combination of these or other types of networks.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the example environment 200 may perform one or more functions described as being performed by another set of devices of the example environment 200.

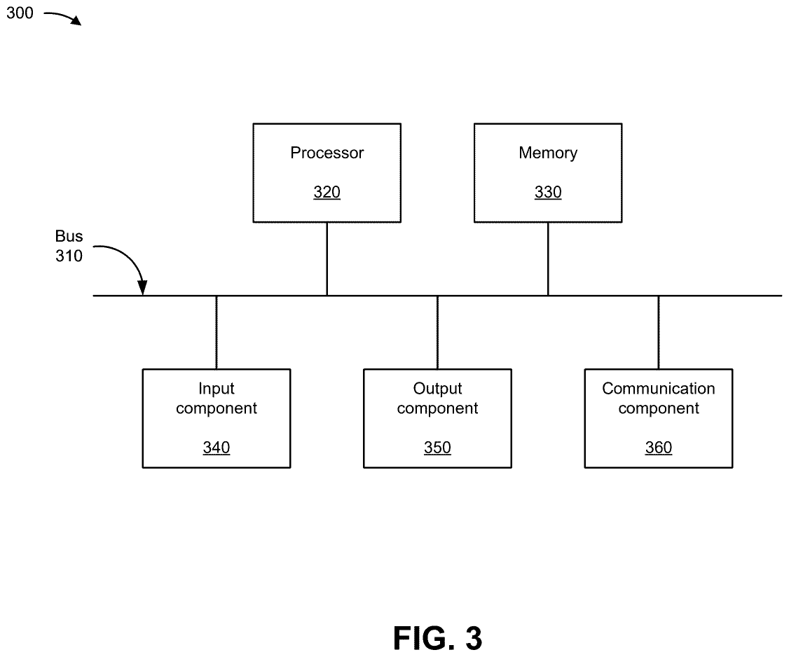

FIG. 3 is a diagram of example components of a device 300, which may correspond to the UE 105, the RAN 110, the NSSF 205, the NEF 210, the AUSF 215, the UDM 220, the PCF 225, the AF 230, the AMF 235, the SMF 240, the UPF 245, and/or the UDR 250. In some implementations, the UE 105, the RAN 110, the NSSF 205, the NEF 210, the AUSF 215, the UDM 220, the PCF 225, the AF 230, the AMF 235, the SMF 240, the UPF 245, and/or the UDR 250 may include one or more devices 300 and/or one or more components of the device 300. As shown in FIG. 3, the device 300 may include a bus 310, a processor 320, a memory 330, an input component 340, an output component 350, and a communication component 360.

The bus 310 includes one or more components that enable wired and/or wireless communication among the components of the device 300. The bus 310 may couple together two or more components of FIG. 3, such as via operative coupling, communicative coupling, electronic coupling, and/or electric coupling. The processor 320 includes a central processing unit, a graphics processing unit, a microprocessor, a controller, a microcontroller, a digital signal processor, a field-programmable gate array, an application-specific integrated circuit, and/or another type of processing component. The processor 320 is implemented in hardware, firmware, or a combination of hardware and software. In some implementations, the processor 320 includes one or more processors capable of being programmed to perform one or more operations or processes described elsewhere herein.

The memory 330 includes volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. Memory 330 stores information, instructions, and/or software (e.g., one or more software applications) related to the operation of the device 300. In some implementations, the memory 330 includes one or more memories that are coupled to one or more processors (e.g., the processor 320), such as via the bus 310.

The input component 340 enables the device 300 to receive input, such as user input and/or sensed input. For example, the input component 340 may include a touch screen, a keyboard, a keypad, a mouse, a button, a microphone, a switch, a sensor, a global positioning system sensor, an accelerometer, a gyroscope, and/or an actuator. The output component 350 enables the device 300 to provide output, such as via a display, a speaker, and/or a light-emitting diode. The communication component 360 enables the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., the memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

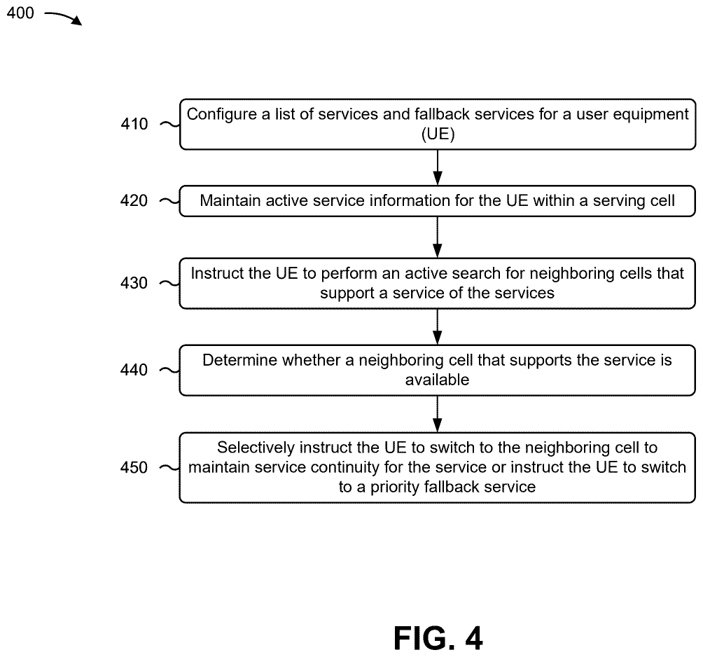

FIG. 4 is a flowchart of an example process 400 for providing RAN service continuity during UE mobility. In some implementations, one or more process blocks of FIG. 4 may be performed by a device (e.g., the RAN 110). In some implementations, one or more process blocks of FIG. 4 may be performed by another device or a group of devices separate from or including the device, such as a UE (e.g., the UE 105), and/or the like. Additionally, or alternatively, one or more process blocks of FIG. 4 may be performed by one or more components of the device 300, such as the processor 320, the memory 330, the input component 340, the output component 350, and/or the communication component 360.

As shown in FIG. 4, process 400 may include configuring a list of services and fallback services for a UE (block 410). For example, the device may configure a list of services and fallback services for a UE based on parameters, as described above.

As further shown in FIG. 4, process 400 may include maintaining active service information for the UE within a serving cell (block 420). For example, the device may maintain active service information for the UE within a serving cell, as described above. In some implementations, maintaining the active service information for the UE within the serving cell includes receiving the active service information through extended UE context information. In some implementations, maintaining the active service information for the UE within the serving cell includes obtaining the active service information via radio access technology frequency selection priority and service profile identifier values. In some implementations, maintaining the active service information for the UE within the serving cell includes obtaining the active service information via target network slice selection assistance information.

As further shown in FIG. 4, process 400 may include instructing the UE to perform an active search for neighboring cells that support a service of the services (block 430). For example, the device may instruct the UE to perform an active search for neighboring cells that support a service of the services, as described above.

As further shown in FIG. 4, process 400 may include determining whether a neighboring cell that supports the service is available (block 440). For example, the device may determine whether a neighboring cell that supports the service is available based on the active search performed by the UE, as described above. In some implementations, determining whether the neighboring cell that supports the service is available includes comparing measurement reports from the UE with profiles of the neighboring cells, and determining whether the neighboring cell that supports the service is available based on comparing the measurement reports with the profiles.

As further shown in FIG. 4, process 400 may include selectively instructing the UE to switch to the neighboring cell to maintain service continuity for the service or instructing the UE to switch to a priority fallback service (block 450). For example, the device may selectively instruct, based on determining that the neighboring cell that supports the service is available, the UE to switch to the neighboring cell to maintain service continuity for the service, or may instruct the UE to switch to a priority fallback service based on determining that the neighboring cell that supports the service is not available, as described above.

In some implementations, instructing the UE to perform the active search for the neighboring cells that support the service includes configuring measurement objects for inter-frequency neighboring cells that support the service. In some implementations, instructing the UE to switch to the priority fallback service includes configuring the UE to search for priority fallback services in service fallback areas. In some implementations, instructing the UE to switch to the neighboring cell includes performing an inter-frequency handover to the neighboring cell that supports the service. In some implementations, instructing the UE to switch to the neighboring cell includes performing an intra-frequency handover to the neighboring cell that supports the service. In some implementations, instructing the UE to switch to the priority fallback service includes performing an inter-radio access technology handover to a neighboring cell that supports the priority fallback service. In some implementations, instructing the UE to switch to the priority fallback service includes prioritizing the fallback services based on priority rules, and instructing the UE to search for a neighboring cell that supports the priority fallback service based on prioritizing the fallback services.

In some implementations, process 400 includes prioritizing the fallback services based on a predefined priority list for the UE. In some implementations, process 400 includes directing, after instructing the UE to switch to a priority fallback service, the UE to switch back to the service when the UE moves back into a service area of the serving cell that supports the service.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

As used herein, “selectively” performing an operation means to either perform the operation or refrain from performing the operation. For example, selectively performing an operation based on whether a condition is satisfied means that the operation is performed if the condition is satisfied and that the operation is not performed if the condition is not satisfied (or vice versa). Thus, selectively performing an operation may include determining whether to perform the operation and then either performing the operation or refraining from performing the operation based on that determination.

As used herein, “selectively” performing a first operation or a second operation means to perform either the first operation or the second operation. For example, selectively performing a first operation or a second operation based on whether a condition is satisfied means that the first operation is performed if the condition is satisfied and that the second operation is performed if the condition is not satisfied (or vice versa). Thus, selectively performing a first operation or a second operation may include determining whether to perform either the first operation or the second operation and then performing either the first operation or the second operation based on that determination.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
configuring, by a device, a list of services and fallback services for a user equipment (UE) based on parameters;
maintaining, by the device, active service information for the UE within a serving cell;
instructing, by the device, the UE to perform an active search for neighboring cells that support a service of the services;
determining, by the device, whether a neighboring cell that supports the service is available based on the active search performed by the UE; and
selectively:
instructing, by the device and based on determining that the neighboring cell that supports the service is available, the UE to switch to the neighboring cell to maintain service continuity for the service; or
instructing, by the device, the UE to switch to a priority fallback service based on determining that the neighboring cell that supports the service is not available.

2. The method of claim 1, wherein maintaining the active service information for the UE within the serving cell comprises:
receiving the active service information through extended UE context information.

3. The method of claim 1, wherein maintaining the active service information for the UE within the serving cell comprises:
obtaining the active service information via radio access technology frequency selection priority and service profile identifier values.

4. The method of claim 1, wherein maintaining the active service information for the UE within the serving cell comprises:
obtaining the active service information via target network slice selection assistance information.

5. The method of claim 1, wherein instructing the UE to perform the active search for the neighboring cells that support the service comprises:
configuring measurement objects for inter-frequency neighboring cells that support the service.

6. The method of claim 1, wherein determining whether the neighboring cell that supports the service is available comprises:
comparing measurement reports from the UE with profiles of the neighboring cells; and
determining whether the neighboring cell that supports the service is available based on comparing the measurement reports with the profiles.

7. The method of claim 1, further comprising:
prioritizing the fallback services based on a predefined priority list for the UE.

8. A device, comprising:
one or more processors configured to:
configure a list of services and fallback services for a user equipment (UE) based on parameters;
prioritize the fallback services based on a predefined priority list for the UE;
maintain active service information for the UE within a serving cell;
instruct the UE to perform an active search for neighboring cells that support a service of the services;
determine whether a neighboring cell that supports the service is available based on the active search performed by the UE; and
selectively:
instruct, based on determining that the neighboring cell that supports the service is available, the UE to switch to the neighboring cell to maintain service continuity for the service; or
instruct the UE to switch to a priority fallback service based on determining that the neighboring cell that supports the service is not available.

9. The device of claim 8, wherein the one or more processors, to instruct the UE to switch to the priority fallback service, are configured to:
configure the UE to search for priority fallback services in service fallback areas.

10. The device of claim 8, wherein the one or more processors, to instruct the UE to switch to the neighboring cell, are configured to:
perform an inter-frequency handover to the neighboring cell that supports the service.

11. The device of claim 8, wherein the one or more processors, to instruct the UE to switch to the neighboring cell, are configured to:
perform an intra-frequency handover to the neighboring cell that supports the service.

12. The device of claim 8, wherein the one or more processors, to instruct the UE to switch to the priority fallback service, are configured to:
perform an inter-radio access technology handover to a neighboring cell that supports the priority fallback service.

13. The device of claim 8, wherein the one or more processors are further configured to:
direct, after instructing the UE to switch to the priority fallback service, the UE to switch back to the service when the UE moves back into a service area of the serving cell that supports the service.

14. The device of claim 8, wherein the one or more processors, to instruct the UE to switch to the priority fallback service, are configured to:
prioritize the fallback services based on priority rules; and
instruct the UE to search for a neighboring cell that supports the priority fallback service based on prioritizing the fallback services.

15. A non-transitory computer-readable medium storing a set of instructions, the set of instructions comprising:
one or more instructions that, when executed by one or more processors of a device, cause the device to:
configure a list of services and fallback services for a user equipment (UE) based on parameters;
maintain active service information for the UE within a serving cell via extended UE context information, radio access technology frequency selection priority and service profile identifier values, or target network slice selection assistance information;
instruct the UE to perform an active search for neighboring cells that support a service of the services;
determine whether a neighboring cell that supports the service is available based on the active search performed by the UE; and
selectively:
instruct, based on determining that the neighboring cell that supports the service is available, the UE to switch to the neighboring cell to maintain service continuity for the service; or
instruct the UE to switch to a priority fallback service based on determining that the neighboring cell that supports the service is not available.

16. The non-transitory computer-readable medium of claim 15, wherein the one or more instructions, that cause the device to instruct the UE to perform the active search for the neighboring cells that support the service, cause the device to:
configure measurement objects for inter-frequency neighboring cells that support the service.

17. The non-transitory computer-readable medium of claim 15, wherein the one or more instructions, that cause the device to determine whether the neighboring cell that supports the service is available, cause the device to:
compare measurement reports from the UE with profiles of the neighboring cells; and
determine whether the neighboring cell that supports the service is available based on comparing the measurement reports with the profiles.

18. The non-transitory computer-readable medium of claim 15, wherein the one or more instructions, that cause the device to instruct the UE to switch to the priority fallback service, cause the device to:
configure the UE to search for priority fallback services in service fallback areas.

19. The non-transitory computer-readable medium of claim 15, wherein the one or more instructions, that cause the device to instruct the UE to switch to the neighboring cell, cause the device to:
perform an inter-frequency handover to the neighboring cell that supports the service.

20. The non-transitory computer-readable medium of claim 15, wherein the one or
more instructions, that cause the device to instruct the UE to switch to the neighboring cell, cause the device to:
perform an intra-frequency handover to the neighboring cell that supports the service.
